(19) United States
(12) Patent Application Publication
(10) Pub. No.: US 2013/0254889 A1
(43) Pub. Date: Sep. 26, 2013

(54) Server-Side Restricted Software Compliance

(71) Applicant: Sky Socket, LLC, Atlanta, GA (US)

(72) Inventor: Erich Stuntebeck, Marietta, GA (US)

(73) Assignee: Sky Socket, LLC, Atlanta, GA (US)

(21) Appl. No.: 13/900,657

(22) Filed: May 23, 2013

Related U.S. Application Data
(63) Continuation-in-part of application No. 13/853,657, filed on Mar. 29, 2013.

(51) Int. Cl. G06F 21/56

(52) U.S. Cl. CPC G06F 21/562
USPC 726/23

(57) ABSTRACT

Server-side restricted software compliance may be provided. An application installed on a user device may be identified and analyzed to determine whether the application comprises a security threat by comparing the application to a copy of the application. In response to determining that the application comprises a security threat, a user of the user device may be notified that the application comprises a security threat.

### RELATED APPLICATION

This application is a Continuation-In-Part of U.S. patent application Ser. No. 13/853,657, entitled “Restricted Software Automated Compliance,” filed on Mar. 29, 2013, and is hereby incorporated by reference in its entirety.

### BACKGROUND

Compliance rules may be provided for handling situations where malicious software (“malware”) is detected on a device. Malware can appear in the form of code, scripts, active content, and other software and includes software such as computer viruses, worms, Trojan horses, rootkits, keyloggers, dialers, spyware, adware, rogue security software, and other malicious programs. Conventional solutions often scan for malware and alert users to the threat, often allowing the threat to be contained by deleting files associated with the malware.

### SUMMARY

This Summary is provided to introduce a selection of concepts in a simplified form that are further described below in the Detailed Description. This Summary is not intended to identify key features or essential features of the claimed subject matter nor is this Summary intended to be used to limit the claimed subject matter's scope.

Server-side restricted software compliance may be provided. An application installed on a user device may be identified and analyzed to determine whether the application comprises a security threat by comparing the application to a copy of the application. In response to determining that the application comprises a security threat, a user of the user device may be notified that the application comprises a security threat.

It is to be understood that both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### BRIEF DESCRIPTION OF THE DRAWINGS

Many aspects of the present disclosure can be better understood with reference to the following diagrams. The drawings are not necessarily to scale. Instead, emphasis is placed upon clearly illustrating certain features of the disclosure. Moreover, in the drawings, like reference numerals designate corresponding parts throughout the several views. In the drawings:

FIG. 1 is a block diagram of a user device;

FIG. 2 is a block diagram of an operating environment; and

FIG. 3 is a flow chart illustrating a method for providing server-side malware compliance.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Devices managed by an enterprise may have profiles and/or management applications (“agents”) installed to monitor the devices for malicious, harmful, or insecure activity. For example, the device may be periodically scanned for malware by the agent and any malicious activity may be reported to a management server. In some embodiments consistent with this disclosure, security may be provided, in addition to and/or in lieu of, the on-device agent by the management server. Such a management server may distribute security and/or compliance polices to the devices that are managed by the enterprise, whether such devices be owned by the enterprise and/or by individual users.

The management server may also communicate with the managed devices to ensure that the security and compliance policies are being obeyed. For example, a security policy may require periodic scans of the devices memory to ensure that certain applications are not installed and/or that non-malicious versions of applications are being used. In some embodiments, this may involve comparing a copy of an application as installed on a device to a copy downloaded directly from a distributor of that application and/or a known good copy verified by the enterprise.

In some embodiments, the policies put in place for each device may vary depending on whether the device is enterprise owned or individually owned. Corporate devices may undergo stricter scrutiny, such as having all installed applications checked on a regular frequency and/or each time an application is launched. Individual devices, such as those used under an enterprise's “Bring Your Own Device” program, may have only certain applications checked to avoid breaches of the device owners' privacy. For example, applications may only be checked while the device has an active connection to an enterprise network, such as a Local Area Network (LAN) in an office or via a Virtual Private Network (VPN). Conversely, individual owned devices may be considered less trustworthy in some embodiments and may consequently be checked for security vulnerabilities and malware more often and/or more strictly than corporate owned devices.

The technical effects of some embodiments of this disclosure may include establishing control of access to networks and resources when access lists may not be predefined, and reducing and/or eliminating the burden of predefining access lists to control access to networks and resources. Moreover, the technical effects of some embodiments may include enhancing network access control by assigning specific access rights based on access lists to client devices authorized to access associated network beacons and resources.

Other technical effects of some embodiments of this disclosure may offer group management solutions to managing content access and distribution. For example, users of a sales group may have read access to marketing documents and presentations, while users in a marketing group may be able to edit and/or annotate the market documents. Similarly, users in an accounting or business services group may be the only ones with access to enterprise financial documents. These access controls may be provided by distributing authorization credentials to devices associated with users of the respective group. Each user may then authenticate to their device, such as by inputting a username, password, authentication key, and/or biometric data, before the device may access and/or retrieve the content authorized for distribution to that device. These authentication types are provided as examples only and are not intended to be limiting as many other types of user authentication are in use and/or may be contemplated in the future.

Content access may be further limited by policies that enforce other compliance restrictions based on properties of the device such as time, location, device security and/or integrity, presence of another device, software versions, required software, etc. For example, educational settings may designate student and instructor groups. These groups may be further assigned to specific classes such that only student group members associated with a given class may access content associated with that class. Further, edit access to the content for the class may be restricted to the user(s) in the instructor group and/or student group members may be permitted to add content that only the instructor may view (e.g., homework assignments.) In some embodiments, the instructor group user(s) may be able to push content to student group user(s) and/or activate temporary control of the students' devices to prevent the devices from accessing non-class related content during class time.

To reduce the cost of ownership of user devices and cellular and/or data service charges associated with use of such user devices, a business may implement a “bring your own device” (BYOD) policy to allow an employee to use his/her personal device to access business resources rather than provide the employee with a business owned user device for such purpose. To support such a BYOD policy, a user device administrator (i.e. IT administrator) may manage a group of personally owned user devices, via a management application executed by a management server in communication with the user devices over a network, to provide the user devices with secure access to business resources.

The user device administrator may enroll user devices into the management system to monitor the user devices for security vulnerabilities and to configure the user devices for secure access to business resources. The user device administrator may create and/or configure at least one configuration profile via a user interface provided by the management system. A configuration profile may comprise a set of instructions and/or settings that configure the operations and/or functions of a user device, which may ensure the security of the accessed resources. The user device administrator may, for instance, configure a business email configuration profile by specifying the network address and access credentials of a business email account that the users of the user devices are authorized to access. Other configuration policies may include, but are not limited to, hardware, software, application, function, cellular, text message, and data use restrictions, which may be based at least in part on the current time and/or location of the restricted user device. The user device administrator may thereafter deploy the configuration profiles to specific user devices, such as to groups of user devices of employees with similar roles, privileges and/or titles.

The user devices may also have access to personal configuration profiles that may be created by the users of the user devices. The user devices may, for instance, have access to a personal email configuration profile that was created by a user of the user device to provide access to her personal email account. Thus, a user device enrolled in a BYOD management system may have more than one configuration profile for a given use of the user device, such as a personal email configuration profile and a business email configuration profile that are both used for accessing email accounts on the user device.

The user devices may be instructed to enable and/or disable certain configuration profiles according to authorization rights specified by the user device administrator, such as location and/or time-based authorization rights. For example, a BYOD policy may specify that user devices enrolled in the BYOD management system are authorized for personal use outside of the workday and are authorized for business use during the workday. Similarly, a BYOD device may be restricted to business uses while in work locations and/or prohibited from accessing business resources while outside of secure work locations. To implement such a policy, a user device administrator may instruct the user devices to toggle between personal configuration policies and business configuration policies based on factors such as the current time and/or location associated with the user device. The current time may be based on the current time at the current location of the user device, which may be determined by GPS, Wi-Fi, Cellular Triangulation, etc., or may be based on the current time at a configured primary location associated with the user device, which may be the primary office location of an employee user of the user device. As an example, time-based configuration profile toggling may be provided by instructing a user device to enable business configuration profiles and disable personal configuration profiles while the current time is between 9 AM and 5 PM at the current location of the user device, and to disable business configuration profiles and enable personal configuration profiles while the current time is between 5 PM and 9 AM at the current location of the user device.

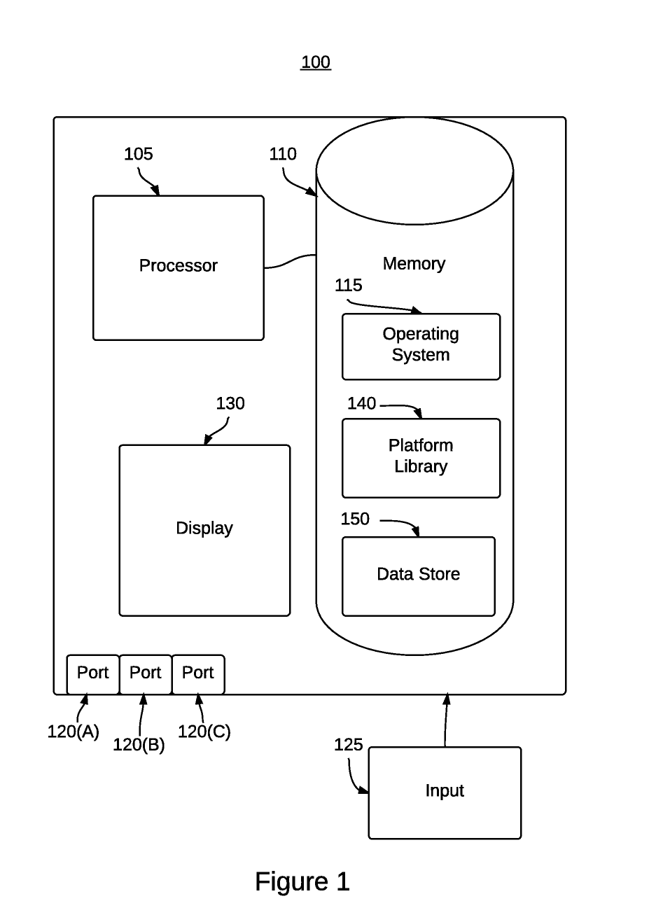

FIG. 1 is a block diagram of a user device 100 comprising a processor 105 and a memory 110. Depending on the configuration and type of device, memory 110 may comprise, but is not limited to, volatile (e.g. random access memory (RAM)), non-volatile (e.g. read-only memory (ROM)), flash memory, or any combination. Memory 110 may store executable programs and related data components of various applications and modules for execution by user device 100. Memory 110 may be coupled to processor 105 for storing configuration data and operational parameters, such as commands that are recognized by processor 105.

Basic functionality of user device 100 may be provided by an operating system 115 contained in memory 100. One or more programmed software applications may be executed by utilizing the computing resources in user device 100. Applications stored in memory 110 may be executed by processor 105 (e.g., a central processing unit or digital signal processor) under the auspices of operating system 115. For example, processor 105 may be configured to execute applications such as web browsing applications, email applications, instant messaging applications, and/or other applications capable of receiving and/or providing data.

Data provided as input to and generated as output from the application(s) may be stored in memory 110 and read by processor 105 from memory 110 as needed during the course of application program execution. Input data may be data stored in memory 110 by a secondary application or other source, either internal or external to user device 100, or possibly anticipated by the application and thus created with the application program at the time it was generated as a software application program. Data may be received via any of a plurality of communication ports 120(A)-(C) of user device 100. Communication ports 120(A)-(C) may allow user device 100 to communicate with other devices, and may comprise components such as an Ethernet network adapter, a modem, and/or a wireless network connectivity interface. For example, the wireless network connectivity interface may comprise one and/or more of a PCI (Peripheral Component Interconnect) card, USB (Universal Serial Bus) interface, PCMCIA (Personal Computer Memory Card International Association) card, SDIO (Secure Digital Input-Output) card, NewCard, Cardbus, a modem, a wireless radio transceiver, and/or the like.

User device 100 may also receive data as user input via an input component 125, such as a keyboard, a mouse, a pen, a stylus, a sound input device, a touch input device, a capture device, etc. A capture device may be operative to record user(s) and capture spoken words, motions and/or gestures, such as with a camera and/or microphone. The capture device may comprise any speech and/or motion detection device capable of detecting the speech and/or actions of the user(s).

Data generated by applications may be stored in memory 110 by the processor 105 during the course of application program execution. Data may be provided to the user during application program execution by means of a display 130. Consistent with embodiments of this disclosure, display 130 may comprise an integrated display screen and/or an output port coupled to an external display screen.

Memory 110 may also comprise a platform library 140. Platform library 140 may comprise a collection of functionality useful to multiple applications, such as may be provided by an application programming interface (API) to a software development kit (SDK). These utilities may be accessed by applications as necessary so that each application does not have to contain these utilities thus allowing for memory consumption savings and a consistent user interface.

Furthermore, embodiments of this disclosure may be practiced in conjunction with a graphics library, other operating systems, or any other application program and is not limited to any particular application or system. The devices described with respect to the Figures may have additional features or functionality. For example, user device 100 may also include additional data storage devices (removable and/or non-removable) such as, for example, magnetic disks, optical disks, or tape (not shown).

User device 100 may comprise a desktop computer, a laptop computer, a personal digital assistant, a cellular telephone, a set-top box, a music player, a web pad, a tablet computer system, a game console, and/or another device with like capability.

User device 100 may store in a data store 150 a device profile 152 and a user profile 154. Device profile 152 may comprise, for example, an indication of the current position of user device 100 and/or indications of the hardware, software, and security attributes, which describe user device 100. For instance, device profile 152 may represent hardware specifications of user device 100, version and configuration information of various software program and hardware components installed on user device 100, data transmission protocols enabled on user device 100, version and usage information of various resources stored on user device 100, and/or any other attributes associated with the state of user device 100. The device profile 152 may further comprise data indicating a date of last virus scan of user device 100, a date of last access by an IT representative, a date of last service by the IT representative, and/or any other data indicating maintenance and usage of user device 100. Furthermore, the device profile 152 may comprise indications of the past behavior of associated users, such as resources accessed, charges for resource accesses, and the inventory accessed from such resources. The device profile 152 may also comprise device identifiers that may uniquely identify the user device 100. In some embodiments, the device identifiers may be a unique hardware identifier such as a GUID (Globally Unique Identifier), UUID (Universally Unique Identifier), UDID (Unique Device Identifier), serial number, IMEI (Internationally Mobile Equipment Identity), Wi-Fi MAC (Media Access Control) address, Bluetooth MAC address, a CPU ID, and/or the like, or any combination of two or more such hardware identifiers. In some embodiments, the device identifier may be a unique software identifier such a token or certificate, based at least in part on the aforementioned unique hardware identifiers.

User profile 154 may comprise one or more user identifiers that uniquely identify the user of the user device 100 and/or a listing of factors that may affect the experience of the user. In some embodiments, the user identifiers may include a username, a password, and/or biometric data related to facial recognition, retina recognition, fingerprint recognition, and the like. The user preferences may comprise indications of the user's age, gender, bodily traits, preferred resource types, preferred venue resources, and combinations thereof.

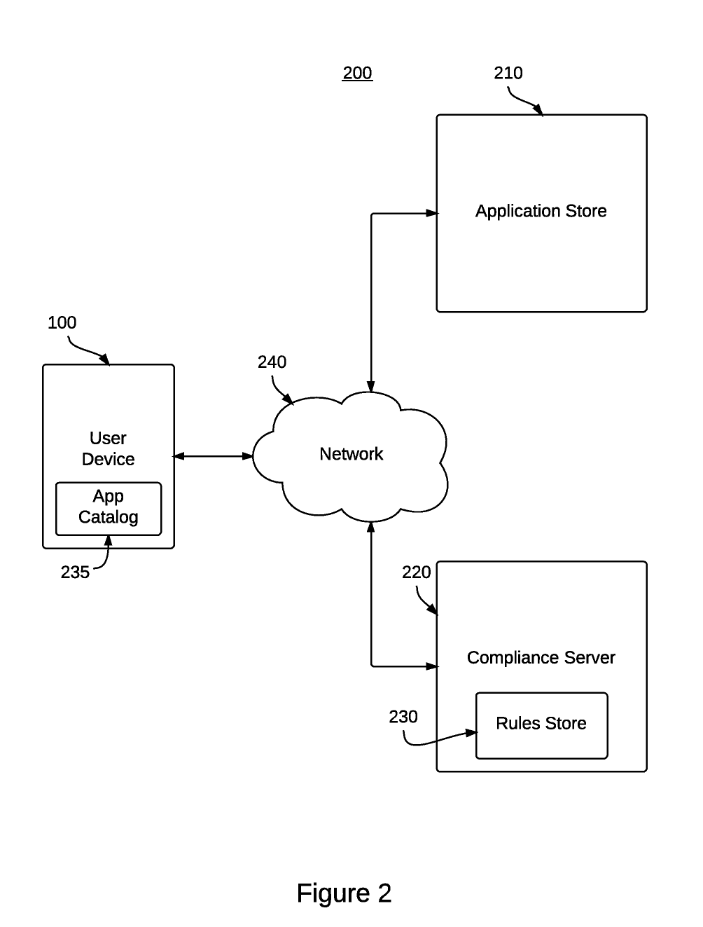

FIG. 2 is a block diagram view of an operating environment 200 comprising user device 100 in communication with an application store 210 and a compliance server 220 via a network 240. The application store 210 and compliance server 220 may comprise, for example, cloud-based solutions, server computers and/or any other system providing application distribution capability. For purposes of convenience, the application store 210 and compliance server 220 are referred to herein in the singular, although it is understood that a plurality of servers may be employed in the arrangements as descried herein. Furthermore, in some embodiments, application store 210 and compliance server 220 may operate on the same server computer. The components executed on the application store 210 and/or the compliance server 220, for example, may comprise various applications, services, processes, systems, engines, or functionality not disclosed in detail herein.

The application store 210 may comprise a digital distribution platform for application software, often provided as a component of an operating system on a personal computer, smartphone, or tablet. Application stores typically take the form of an online store, where users can browse through different categories and genres of applications (e.g., productivity, multimedia, games, etc.), view information and reviews of then, purchase it (if necessary), and then download and install the application on their device.

The compliance server may comprise a rules store 230 comprising a plurality of compliance rules that may be applicable to user device 100. Attempts by user device 100 to access various resources on user device 100 or located remotely, such as at application store 210, may require user device 100 to be in compliance with one and/or more of the compliance rules.

Depending on the sensitivity of a given resource, different compliance rules may be necessary to ensure that the resource is adequately protected. Some resources may only require ensuring that the proper user is requesting the resource. Other resources may require compliance with more stringent authorization rules, such as determining whether an appropriate transport protocol is used (i.e., http and/or https) by the requesting device, determining whether access to the resource is permitted for a specified duration or at a given time, determining whether the resource is accessed from a secured device, etc. The compliance server 220 may be operative to determine whether a pairing of the user device 100 and a specific user of user device 100 are authorized to communicate with various resources based at least in part on the compliance rules.

In some embodiments, the compliance rules may comprise application white lists comprising a listing of applications allowed to be installed and/or executed on user device 100. The compliance rules may comprise application black lists comprising a listing of applications forbidden to be installed and/or executed on user device 100. Furthermore, the compliance rules may comprise a list of functions, such as those provided by APIs associated with operating system 115 and/or platform library 140, that may be treated as protected functions. Calls to these functions, such as calls to retrieve login credentials, may result in checks for compliance with the compliance rules.

The network 240 may comprise, for example, any type of wired and/or wireless network such as a wireless local area network (WLAN), a wireless wide area network (WWAN), Ethernet, fiber-optic network, and/or any other type of wired and/or wireless network now known or later developed. Additionally, the network 110 may be or include the Internet, intranets, extranets, microwave networks, satellite communications, cellular systems, PCS, infrared communications, global area networks, or other suitable networks, etc., or any combination of such networks.

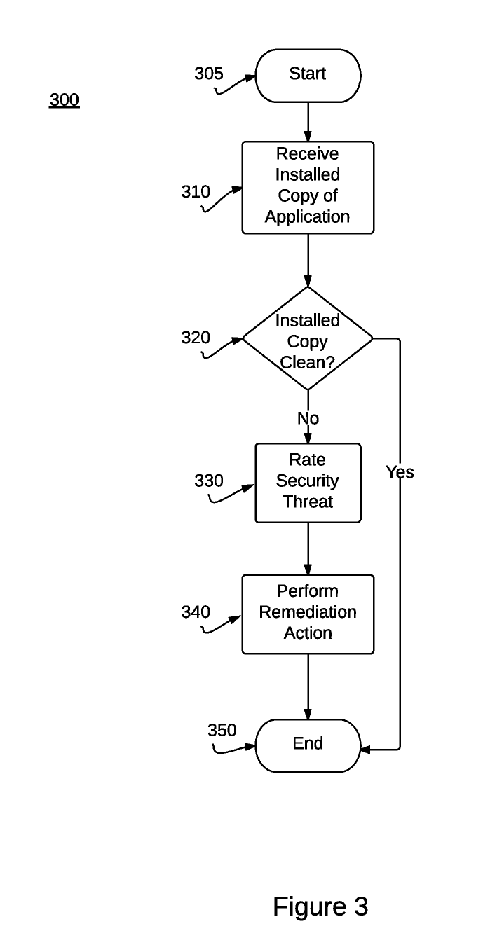

FIG. 3 is a flow chart setting forth the general stages involved in a method 300 consistent with embodiments of this disclosure for providing automated restricted software compliance. Ways to implement the stages of method 300 will be described in greater detail below. For purposes of illustration, not limitation, method 300 is described with respect to user device 100 in communication with application store 210 and/or compliance server 220. In various embodiments, the stages of method 300 may be performed by any of the elements described in operating environment 200. Method 300 may begin at starting block 305 and proceed to stage 310 where compliance server 220 may receive a copy of an application installed on user device 100. For example, compliance server 220 may download and/or pull a copy of a web browser application from app catalog 235 on user device 100. For another example, user device 100 may upload and/or push a copy of the web browser application to compliance server 220. This stage may occur on a periodic basis, on command from an administrator and/or a user, and/or each time an application is downloaded, modified, and/or updated on user device 100.

Method 300 may then advance to stage 320 where compliance server 220 may determine whether the copy of the application as installed on the user device 100 comprises a clean copy of the application. For example, compliance server 220 may download a second copy of the application from a distributor and/or author of the application, download a second copy of the application from an application store associated with a type of user device 100 (e.g., the Apple® App Store, the Google® Play store, etc.), and/or may use a verified copy of the application stored in a memory of the compliance server 220. Such a verified copy may comprise an original and/or a modified version of the application that has been analyzed and vetted as not comprising malicious software and/or security vulnerabilities. For example, an IT administrator may perform an analysis to confirm the absence of viruses and spyware within the verified copy of the application. Similarly, the IT administrator may analyze the functions and structure of the application, such as Application Programming Interface (API) calls, performed by the application to confirm that no security flaws are present. In some embodiments, verified copies of the application may be provided by a distributor and/or a third party verification service associated with the application, such as by using digital signatures on the application's executable comprising, for example, a cryptographic hash.

If the installed copy of the application is determined not to comprise a clean copy, method 300 may advance to stage 330 where compliance server 220 may rate a threat level of the installed copy of the application. For example, an old version of the application may be rated as a minor threat, insecure API calls may be rated as an average threat, and an actively harmful virus may be rated as a serious threat. The threat levels may be configurable by an administrator of compliance server 220 and/or may be drawn from publicly available ratings of security threats, such as those often provided by anti-virus software distributors.

Method 300 may then advance to stage 340 where compliance server 220 may perform a remediation action. For example, compliance server 220 may de-authorize user device 100 from accessing resources associated with the enterprise, whether stored on user device 100 and/or remotely, until the threat from the application has been addressed. For another example, compliance server 220 may instruct user device 100 to perform a remediation action such as uninstalling the application and/or downloading a new copy of the application. In some embodiments, compliance server 220 may also initiate a review of other user devices that have the same application installed to determine whether the same and/or another threat exists on those other devices. After performing the remediation action, or if the installed copy of the application is determined to be clean at stage 320, method 300 may end at stage 350.

An embodiment consistent with the disclosure may comprise a system for providing secure application leveraging of a filter proxy service. The system may comprise a memory storage and a processing unit coupled to the memory storage. The processing unit may be operative to identify an application installed on a user device, determine whether the application comprises a security threat by comparing the application to a copy of the application, and, in response to determining that the application comprises a security threat, notify a user of the user device that the application comprises a security threat. A copy of the application may be downloaded from, for example, a distributor of the application such as a publicly accessible application store and/or a private application store associated with an enterprise. If the application is determined to comprise a security threat, a notification may be provided to a user of the user device, an administrator (e.g., an IT administrator responsible for managing the device), and/or the application may be disabled and/or deleted. Upon detection of a threat in the application, other copies of the application such as may be installed on other devices may be analyzed as well by comparison to a copy of the application.

Another embodiment consistent with the disclosure may comprise a system for providing secure application leveraging of a filter proxy service. The system may comprise a memory storage and a processing unit coupled to the memory storage. The processing unit may be operative to provide a copy of the application as installed in the memory storage to a compliance application, receive a compliance report on the copy of the application, determine, according to the compliance report on the copy of the application, whether the application installed in the memory storage comprises a security risk, and in response to determining, according to the compliance report on the copy of the application, that the application installed in the memory storage comprises a security risk, perform at least one remediation action. In some embodiments, the request to evaluate the application may comprise a plurality of applications to be evaluated, such as multiple application on one device and/or copies of the same application as installed on multiple devices. The compliance report may comprise a severity rating of the security threat and/or a recommended remediation action based on the severity rating of the security threat.

Yet another embodiment consistent with the disclosure may comprise a system for providing secure application leveraging of a filter proxy service. The system may comprise a memory storage and a processing unit coupled to the memory storage. The processing unit may be operative to receive a first copy of an executable application, compare the first copy of the executable application to at least one second copy of the executable application, determine whether the first copy of the executable application substantially matches the at least one second copy of the executable application, and in response to determining that the first copy of the executable application does not substantially match the at least one second copy of the executable application, perform a remediation action. The processing unit being operative to determine whether the first copy of the executable application substantially matches the at least one second copy of the executable action may comprise the processing unit being operative to compute a first checksum on at least a portion of the first copy of the application, compute a second checksum on at least a portion of the second copy of the application, and determine whether the first checksum is equal to the second checksum. For example, a checksum may be computed for a signature associated with the application, for one and/or more of a plurality of files associated with the application, a library associated with the application, a memory stack associated with the application, etc.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of this disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. The Figures above and their associated descriptions provide a discussion of a variety of operating environments in which embodiments of this disclosure may be practiced. However, the devices and systems illustrated and discussed with respect to the Figures are for purposes of example and illustration and are not limiting of a vast number of computing device configurations that may be utilized for practicing embodiments of this disclosure as described herein.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

A number of applications and data files may be used to perform processes and/or methods as described above. The aforementioned processes are examples, and a processing unit may perform other processes. Other programming modules that may be used in accordance with embodiments of this disclosure may include electronic mail, calendar, and contacts applications, data processing applications, word processing applications, spreadsheet applications, database applications, slide presentation applications, drawing or computer-aided application programs, etc.

Generally, consistent with embodiments of this disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of this disclosure may also be practiced in distributed computing environments where tasks are performed by remote processing devices that are linked through a communications network. In a distributed computing environment, program modules may be located in both local and remote memory storage devices.

Furthermore, embodiments of this disclosure may be practiced in an electrical circuit comprising discrete electronic elements, packaged or integrated electronic chips containing logic gates, a circuit utilizing a microprocessor, or on a single chip containing electronic elements or microprocessors. Embodiments of this disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of this disclosure may, for example, be implemented as a computer process and/or method, a computing system, an apparatus, device, or appliance, and/or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of this disclosure may be practiced via a system-on-a-chip (SOC) where each and/or many of the elements described above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any element may operate via application-specific logic integrated with other components of the computing device/system on the single integrated circuit (chip).

Embodiments of this disclosure are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in any code included herein are vested in and the property of the Assignee. The Assignee retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
identifying an application installed on a user device;
determining whether the application comprises a security threat by comparing the application to a copy of the application;
in response to determining that the application comprises a security threat, notifying a user of the user device that the application comprises a security threat.

2. The method of claim 1, wherein the user device comprises at least one of the following: a server, a desktop computer, a laptop computer, a personal digital assistant, a cellular telephone, a set-top box, a music player, a web pad, a tablet computer system, a game console.

3. The method of claim 1, further comprising downloading the copy of the application from a distributor of the application.

4. The method of claim 3, wherein the distributor of the application comprises a publicly accessible application store.

5. The method of claim 3, wherein the distributor of the application comprises a private application store associated with an enterprise.

6. The method of claim 1, further comprising:
in response to determining that the application comprises a security threat, disabling the application.

7. The method of claim 1, further comprising:
in response to determining that the application comprises a security threat, deleting the application.

8. The method of claim 1, further comprising:
in response to determining that the application comprises a security threat, notifying an administrator that the application comprises a security threat.

9. The method of claim 1, further comprising:
in response to determining that the application comprises a security threat, determining whether a second copy of the application installed on at least one second user device comprises a security threat by comparing the application to the copy of the application.

10. The method of claim 1, further comprising:
in response to determining that the application comprises a security threat, determining whether a second copy of the application installed on at least one second user device comprises a security threat by comparing the second copy of the application to the application installed on the user device.

11. An apparatus comprising:
a memory storage; and
a processor coupled to the memory storage, wherein the processor is configured to:
receive a request to evaluate an application installed in the memory storage for a security risk,
provide a copy of the application as installed in the memory storage to a compliance application,
receive a compliance report on the copy of the application,
determine, according to the compliance report on the copy of the application, whether the application installed in the memory storage comprises a security risk, and
in response to determining, according to the compliance report on the copy of the application, that the application installed in the memory storage comprises a security risk, perform at least one remediation action.

12. The apparatus of claim 11, wherein the request to evaluate the application comprises a plurality of applications to be evaluated.

13. The apparatus of claim 11, wherein the processor is configured to execute the compliance application.

14. The apparatus of claim 11, being configured to provide the copy of the application as installed in the memory storage to the compliance application comprises the processor being configured to transmit the copy of the application as installed to a communicatively coupled server.

15. The apparatus of claim 11, wherein the compliance report comprises a severity rating of the security threat.

16. The apparatus of claim 15, wherein the at least one remediation action comprises one of a plurality of remediation actions and wherein the at least one remediation action is associated with the severity rating of the security threat.

17. A computer-readable medium which stores a set of instructions that when executed performs a method executed by the set of instructions comprising:
receiving a first copy of an executable application;
comparing the first copy of the executable application to at least one second copy of the executable application;
determining whether the first copy of the executable application substantially matches the at least one second copy of the executable application; and
in response to determining that the first copy of the executable application does not substantially match the at least one second copy of the executable application, performing a remediation action.

18. The computer-readable medium of claim 17, wherein determining whether the first copy of the executable application substantially matches the at least one second copy of the executable action comprises:
computing a first checksum on at least a portion of the first copy of the application;
computing a second checksum on at least a portion of the second copy of the application; and
determining whether the first checksum is equal to the second checksum.

19. The computer-readable medium of claim 17, wherein the first copy of the application is received from a distribution source associated with the application and the at least one second copy of the application comprises an installed copy of the application associated with a user device.

20. The computer-readable medium of claim 17, wherein the first copy of the application comprises a validated copy of the application and the at least one second copy of the application comprises an installed copy of the application associated with a user device.
